(19) United States
(12) Patent Application Publication
(10) Pub. No.: US 2020/0274835 A1
(43) Pub. Date: Aug. 27, 2020

(54) METHODS AND APPARATUSES FOR MANAGING INTEGRATION OF A THIRD PARTY RESOURCE IN A GROUP-BASED COMMUNICATION SYSTEM

(71) Applicant: Slack Technologies, Inc., San Francisco, CA (US)

(72) Inventors: Lorilyn McCue, San Francisco, CA (US); Raquel Vélez, San Francisco, CA (US); Jessica Phan, San Francisco, CA (US); Michael Deng, San Francisco, CA (US); Ryan Mah, San Francisco, CA (US); Martin Castellanos, San Francisco, CA (US); Melissa Khuat, San Francisco, CA (US); Mark Pike, San Francisco, CA (US); Kefan Xie, San Francisco, CA (US)

(73) Assignee: Slack Technologies, Inc., San Francisco, CA (US)

(21) Appl. No.: 16/801,074

(22) Filed: Feb. 25, 2020

Related U.S. Application Data
(60) Provisional application No. 62/810,175, filed on Feb. 25, 2019.

(51) Int. Cl. H04L 12/58

(52) U.S. Cl. CPC H04L 51/046; H04L 51/18; H04L 51/16

(57) ABSTRACT

Methods, systems, and apparatuses for programmatically managing integration of a third party resource in a group-based communication system are provided herein.

### CROSS-REFERENCE TO RELATED APPLICATIONS

This application claims priority to U.S. Provisional Application Ser. No. 62/810,175, titled “METHODS AND APPARATUSES FOR MANAGING INTEGRATION OF A THIRD PARTY RESOURCE IN A GROUP-BASED COMMUNICATION SYSTEM,” filed Feb. 25, 2019, which is incorporated herein by reference in its entirety.

### TECHNOLOGICAL FIELD

Embodiments of the invention relate, generally, to programmatically managing integration of a third party resource in a group-based communication system.

### BACKGROUND

Various messaging systems may support communication and collaboration among users across an organization. A third party resource provider may provide a third party resource among users within a communication system. Applicant has identified a number of deficiencies and problems associated with collaborative communication environments. Through applied effort, ingenuity, and innovation, many of these identified problems have been solved by developing solutions that are included in embodiments of the present disclosure, many examples of which are described in detail herein.

### BRIEF SUMMARY

This specification relates to methods, systems, apparatuses, and computer program products for an apparatus configured to programmatically manage integration of a third party resource in a group-based communication system.

In some embodiments of the present disclosure, an apparatus may be provided for managing integration of a third party resource in a group-based communication system, the apparatus comprising at least one processor and at least one memory including a computer program code, the at least one memory and the computer program code configured to, with the at least one processor, cause the apparatus to receive a workspace creation request from a client device associated with a first user profile. The memory including the program code is further configured to, with the processor, cause the apparatus to generate and store, in response to receiving the workspace creation request, a group identifier associated with a new workspace. The memory including the program code is further configured to, with the processor, cause the apparatus to associate the group identifier with a third party resource provider identifier. The memory including the program code is further configured to, with the processor, cause the apparatus to identify a second user profile associated with the group identifier. The memory including the program code is further configured to, with the processor, cause the apparatus to generate a third party resource integration interface comprising the third party resource provider identifier. The memory including the program code is further configured to, with the processor, cause the apparatus to cause rendering of the third party resource integration interface in a group-based communication interface associated with the group identifier. The third party resource integration interface is engageable to cause receiving of a third party resource integration user confirmation. The third party resource integration user confirmation comprises a third party user account identifier. The memory including the program code is further configured to, with the processor, cause the apparatus to, upon receiving the third party resource integration user confirmation, transmit, to the third party resource provider, a third party user account integration request comprising the third party user account identifier. The memory including the program code is further configured to, with the processor, cause the apparatus to receive, from the third party resource provider, a third party resource integration provider confirmation comprising a third party resource access token.

In some embodiments, the third party resource provider identifier is previously associated with another group identifier associated with the first user profile. In some embodiments, a third party resource identified by the third party resource provider identifier is integrated within the group-based communication system and utilized in one or more other workspaces associated with an organization identifier associated with the first user profile identifier.

In some embodiments, the third party resource integration interface is configured to, when engaged, to render a description associated with the third party resource provider.

In some embodiments, the description further comprises description for one or more access rights comprising one or more of: right to transmit third party resource access token, right to transmit group-based communication message, right to access one or more email addresses associated with one or more user identifiers associated with the workspace, or right to access information regarding one or more group-based communication channel associated with the second user profile.

In some embodiments, the third party resource integration interface is further engageable to cause receiving of a third party resource integration user dismissal.

In some embodiments, the at least one memory and the computer program code further configured to, with the at least one processor, cause the apparatus to: record a number of interactions with the third party resource integration interface that indicates a third party resource integration user dismissal.

In some embodiments, the at least one memory and the computer program code further configured to, with the at least one processor, cause the apparatus to record a number of interactions with the third party resource integration interface that indicates a third party resource integration user confirmation.

In some embodiments, the second user profile is previously associated with an email address associated with the third party resource provider identifier.

In another example embodiment, an apparatus is provided for managing integration of a third party resource in a group-based communication system, the apparatus comprising at least one processor and at least one memory including a computer program code, the at least one memory and the computer program code configured to, with the at least one processor, cause the apparatus to receive a workspace creation request from a client device associated with a first user profile. The memory including the program code is further configured to, with the processor, cause the apparatus to identify a first organization identifier associated with the first user profile. The memory including the program code is further configured to, with the processor, cause the apparatus to identify a second organization identifier with an organization similarity score higher than a pre-defined threshold between the first organization identifier and the second organization identifier. The memory including the program code is further configured to, with the processor, cause the apparatus to access a third party resource usage map associated with the second organization identifier to identify a most-utilized third party resource identifier associated with the second organization identifier. The memory including the program code is further configured to, with the processor, cause the apparatus to store the most-utilized third party resource identifier for future rendering of a third party resource integration interface identifying the most-utilized third party resource identifier.

In another example embodiment, a computer-implemented method may be provided for programmatically managing integration of a third party resource in a group-based communication system, the method includes receiving a workspace creation request from a client device associated with a first user profile. The method further includes generating and storing, in response to receiving the workspace creation request, a group identifier associated with a new workspace. The method further includes associating the group identifier with a third party resource provider identifier. The method further includes identifying a second user profile associated with the group identifier. The method further includes generating a third party resource integration interface comprising the third party resource provider identifier. The method further includes causing rendering of the third party resource integration interface in a group-based communication interface associated with the group identifier. The third party resource integration interface is engageable to cause receiving of a third party resource integration user confirmation. The third party resource integration user confirmation comprises a third party user account identifier. The method further includes, upon receiving the third party resource integration user confirmation, transmitting, to the third party resource provider, a third party user account integration request comprising the third party user account identifier. The method further includes receiving, from the third party resource provider, a third party resource integration provider confirmation comprising a third party resource access token.

In some embodiments, the third party resource provider identifier is previously associated with another group identifier associated with the first user profile. In some embodiments, a third party resource identified by the third party resource provider identifier is integrated within the group-based communication system and utilized in one or more other workspaces associated with an organization identifier associated with the first user profile identifier.

In some embodiments, the third party resource integration interface is configured to, when engaged, to render a description associated with the third party resource provider.

In some embodiments, the description further comprises description for one or more access rights comprising one or more of: right to transmit third party resource access token, right to transmit group-based communication message, right to access one or more email addresses associated with one or more user identifiers associated with the workspace, or right to access information regarding one or more group-based communication channel associated with the second user profile.

In some embodiments, the third party resource integration interface is further engageable to cause receiving of a third party resource integration user dismissal.

In some embodiments, the method further includes recording a number of interactions with the third party resource integration interface that indicates a third party resource integration user dismissal.

In some embodiments, the method further includes recording a number of interactions with the third party resource integration interface that indicates a third party resource integration user confirmation.

In some embodiments, the second user profile is previously associated with an email address associated with the third party resource provider identifier.

In another example embodiment, a computer-implemented method may be provided for programmatically managing integration of a third party resource in a group-based communication system, the method includes receiving a workspace creation request from a client device associated with a first user profile. The method further includes identifying a first organization identifier associated with the first user profile. The method further includes identifying a second organization identifier with an organization similarity score higher than a pre-defined threshold between the first organization identifier and the second organization identifier. The method further includes accessing a third party resource usage map associated with the first organization identifier to identify a most-utilized third party resource identifier associated with the first organization identifier. The method further includes storing the most-utilized third party resource identifier for future rendering of a third party resource integration interface identifying the most-utilized third party resource identifier.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

Having thus described the disclosure in general terms, reference will now be made to the accompanying drawings, which are not necessarily drawn to scale, and wherein:

FIG. 1 is a system architecture diagram of a group based communication system configured to practice embodiments of the present disclosure;

FIG. 2 is an exemplary schematic diagram of a computing entity according to one embodiment of the present disclosure;

FIG. 3 illustrates an exemplary third party resource usage map for use with embodiments of the present disclosure;

FIGS. 4A and 4B illustrate exemplary processes for programmatically managing integration of a third party resource in a group-based communication system according to example embodiments of the present disclosure;

FIG. 5 illustrates exemplary processes for programmatically managing integration of a third party resource in a group-based communication system according to example embodiments of the present disclosure; and

FIGS. 6A, 6B, and 6C illustrate example third party resource integration interfaces according to example embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Overview

Various embodiments of the present disclosure generally relate to a method and apparatus for programmatically managing integration of a third party resource in a group-based communication system. In various embodiments discussed herein, communication may occur in group-based communication channels in various group-based communication workspaces. Users in a group-based communications channel or group-based communication group often utilize one or more third party resources to accomplish various tasks. For example, in a given group-based communications channel, a first third party resource may be used for document sharing and/or storage, a second third party resource for team planning, another third party resource for business planning, and so on. The first third party resource may provide document sharing, editing, storage, and other features for third party resource users that may or may not be group-based communication system users. A user may access the third party resource for the document sharing, editing, storage, and other features provided while communicating in the group-based communication channels.

Without integration of third party resources, use of multiple third party resources may require a particular user managing multiple different interfaces. For example, a user may need to manage an interface for each of the third party resources and the group-based communication interface itself such as logging into ABCD document management service to upload documents received within a group-based communication system, opening a third party interface to view documents shared within the group-based communication channel, or the like.

Such systems are inefficient because too many interfaces need to be rendered simultaneously. Rendering multiple interfaces at once puts undue strain on the computing resources of a client device. Further, when a user switches between these interfaces, such switching puts even more undue strain on the computing resources of the client device. Therefore, efficient integration of third party resources with the group-based communication system is highly preferred.

To efficiently integrate third party resources, upon receiving a workspace creation request, the group-based communication system may automatically identify a third party resource that may potentially be integrated. For example, the group-based communication system may identify a third party resource that is the most popular among all group-based communication users. In another example, the user requesting creation of the workspace may be an existing user of the group-based communication system. Such an existing user may have a user profile that has one or more identifiable third party resources associated with the user profile. After identifying the third party resource that may potentially be integrated, the group-based communication system may generate and cause rendering of a third party resource integration interface to let the user confirm integration of the third party resource in the newly created workspace. If the user confirms, the group-based communication system may communicate with the third party resource provider to receive necessary data for the integration, such as third party user account identifiers and/or third party resource access token. For example, upon receiving a workspace creation request from an ACME corporation employee, the group-based communication system may generate a third party resource integration interface associated with ABCD document management service to let the ACME corporation employee confirm integration of ABCD document management service in the newly created workspace.

### Definitions

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like. Client devices may be associated with a user of a group-based communication system. The association may be created by way of the client device transmitting registration information for the user to a group-based communication system. In some instances, a client device may be temporarily associated with a user (e.g., only when a user is logged onto the group-based communication system app). In such embodiments, the group-based communication system may receive registration information indicating the user is associated with a client device (e.g., a user may input a serial number of the client device to be associated with the user into the group-based communication system).

Client devices configured in accordance with embodiments described herein are configured to generate geographic location data and/or contextual location data. The term “geographic location data” refers to location data (e.g., latitude and longitude coordinates) that is generated by a global positioning system (GPS) receiver housed within the client device. The GPS receiver receives clock data transmitted by one or more geostationary satellites (e.g., a satellite in a known or knowable position) and/or one or more ground based transmitters (e.g., also in known or knowable positions), compares the received clock data, and computes the geographic location data, which represents a near real-time position for the client device. The term “contextual location data” refers to position or location information that is derived by the client device (or by separate server) based on interactions between the client device and local networks, objects, or devices. Example contextual location data could be derived based on reference to known locations for Wi-Fi routers or Bluetooth devices that are configured to communicate with a client device. A client device may also generate contextual location information based on communicating with radio-frequency identification (RFID) readers or tags, or barcode readers or tags, having known positions.

“Group-based” is used herein to refer to a system, channel, message, or virtual environment that has security sufficient such that it is accessible only to a defined group of users. The group may be defined by common access credentials such as those of an organization or commercial enterprise. Access may further be facilitated by a validated request to join or an invitation originated from one user who has been granted access to the group to another entity who has not been granted access to the group. Group identifiers are used to associate data, information, messages, etc., with specific groups.

The term “group-based communication system” refers to a communications software platform and associated hardware that is configured to support and maintain a plurality of group-based communication interfaces and all associated functionality. Group-based communication system users are organized into organization groups (e.g., employees of different companies may be separate organization groups) and each group interacts with the system via a respective group-based communication interface. For example, the group-based communication system might support, among others, a Slack Corporation group-based communication interface and an ACME Corporation group-based communication interface.

The term “group-based communication server” refers to a software platform and associated hardware that is configured to manage access to the various group-based communication interfaces of the group-based communication system. The group-based communication server is configured to access, maintain, and support application product logic of the group-based communication system and to access one or more data repositories such as a group-based communication repository.

The term “group-based communication interface” refers to a virtual communications environment configured to facilitate user interaction with a group-based communications system. Each group-based communication interface is accessible and viewable to a select group of users, such as a group of employees of a business or organization (e.g., the Slack Corp. interface would be accessible and viewable to the Slack employees however the ACME Corporation group-based communication interface would not be accessible and viewable to Slack employees). The group-based communication interface includes a plurality of group-based communication channels (e.g., a marketing channel, sales channel, accounting channel, etc.), which are defined below. An organization may be associated with an organization identifier.

The term “group-based communication channel” refers to a virtual communications environment or feed that is configured to display messaging communications posted by channel members (e.g., validated users accessing the environment using client devices) that are viewable only to the members of the group. The format of the group-based communication channel may appear differently to different members of the group-based communication channel; however, the content of the group-based communication channel (i.e., messaging communications) will be displayed to each member of the group-based communication channel. For instance, a common set of group-based messaging communications will be displayed to each member of the respective group-based communication channel such that the content of the group-based communication channel (i.e., messaging communications) will not vary per member of the group-based communication channel.

The term “user” should be understood to refer to an individual, group of individuals, business, organization, and the like. Users referred to herein are discussed largely in connection with client device enabled activity for accessing a group-based communication interface (or set of group-based communication interfaces) of a group-based communication system.

The terms “group-based communication channel identifier” or “channel identifier” refer to one or more items of data by which a group-based communication channel may be uniquely identified by a group-based communication system. For example, a group-based communication channel identifier may comprise American Standard Code for Information Interchange (ASCII) text, a pointer, a memory address, and the like.

The terms “group identifier” or “team identifier” refer to one or more items of data by which a group within a group-based communication system may be uniquely identified. For example, a group identifier may comprise ASCII text, a pointer, a memory address, and the like. For example, the group identifier associated with member users of a Slack Corporation workspace (i.e., a group-based communication interface) may be 104356721.

Group-based communication system users are organized into organization groups (e.g., employees of each company may be a separate organization group) and each organization group may have one or more group-based communication channels (explained below) to which users may be assigned or which the users may join (e.g., group-based communication channels may represent departments, geographic locations such as offices, product lines, user interests, topics, issues, and/or the like). A group identifier is used to facilitate access control for a message (e.g., access to the message, such as having the message return as part of search results in response to a search query, may be restricted to those users having the group identifier associated with their user profile). The group identifier may be used to determine context for the message (e.g., a description of the group, such as the name of an organization and/or a brief description of the organization, may be associated with the group identifier).

Group-based communication system users may join group-based communication channels. Some group-based communication channels may be globally accessible to those users having a particular organizational group identifier associated with their user profile (i.e., users who are members of the organization). Access to some group-based communication channels may be restricted to members of specified groups, whereby the group-based communication channels are accessible to those users having a particular group identifier associated with their user profile. The group-based communication channel identifier may be used to facilitate access control for a message (e.g., access to the message, such as having the message return as part of search results in response to a search query, may be restricted to those users having the group-based communication channel identifier associated with their user profile, or who have the ability to join the group-based communication channel). The group-based communication channel identifier may be used to determine context for the message (e.g., a description of the group-based communication channel, such as a description of a project discussed in the group-based communication channel, may be associated with the group-based communication channel identifier).

The term “group-based communication repository” refers to a location outside the client device where group-based communication data corpus is stored, accessed, modified and otherwise maintained by the group-based communication system. The stored data includes information that facilitates the operation of the group-based communication system. The group-based communication repository may be embodied as a data storage device or devices, as a separate database server or servers, or as a combination of data storage devices and separate database servers. Further, in some embodiments, the group-based communication repository may be embodied as a distributed repository such that some of the stored data is stored centrally in a location within the group-based communication system and other data stored in a single remote location or a plurality of remote locations. Alternatively, in some embodiments, the group-based communication repository may be distributed over a plurality of remote storage locations only.

The terms “external work object” or “remote work object” refer to a data structure or a dataset that is received from a validated external resource by a group-based communication system for representing files, calls, tasks, events, messages, notifications, calendar invites, and/or emails that a validated external resource transmits, posts, or shares on behalf of a group-based communication channel member for rendering to a group-based communication interface. An external work object may comprise a file object, a call object, a task object, an event object, a message object, a notification object, or an email object. An external work object may be associated with a user identifier.

The terms “internal work object” or “group-based work object” refer to a data structure or a dataset created by the group-based communication system and reflects data about files, calls, tasks, events, messages, notifications, calendar invites, and/or emails posted by a group-based communication channel member to a group-based communication interface. An internal work object may comprise a file object, a call object, a task object, an event object, a message object, a notification object, or an email object. The internal work object may be associated with one or more of a group-based communication channel member, a group-based communication message, a group-based communication channel, and another external or internal work object. In order to process external work object, a group-based communication system may convert external work object to internal work object.

As used herein, the term “third party resource” refers to a third party application that may be integrated in a group-based communication channel within a group-based communication system and may be accessed by a client device accessing the group-based communication channel. For example, a third party resource may be a Software as a Service (SaaS) product or an Application (App) product that is provided by a third party resource provider and integrated in a group-based communication system. In such an example, a client device accessing the group-based communication system may access the SaaS or App product via a group-based communication channel that a user of the client device is associated with.

As used herein, the term “third party resource provider” refers to a provider of a third party resource by way of a remote networked device, such as a server or processing device, maintained by a third party individual, company, or organization. The third party resource provider may provide a third party resource and integrate the third party resource in a group-based communication system for access by client devices. A client device in a group-based communication system may access a third party resource integrated in the group-based communication system without separately accessing the third party resource via a different system. For example, a third party resource provider may be a Software as a Service (SaaS) product provider or an Application (App) product provider that provides a SaaS or App product integrated in a group-based communication system. In such an example, a client device accessing the group-based communication system may access the SaaS or App product via a group-based communication channel that a user of the client device is associated with. In some embodiments, a third party resource provider may provide cloud storage services.

As used herein, the term “third party resource provider identifier” refers to one or more items of data by which a third party resource provider that provides a third party resource in a group-based communication system may be identified. For example, a third party resource provider identifier may comprise ASCII text, a pointer, a memory address, and the like. The third party resource provider identifiers associated with respective third party resource providers may be stored to a third party resource usage record indicating a client device is authorized to access a third party resource served by a respective third party resource provider. The third party resource provider identifiers may be maintained, updated, and stored to a third party resource usage map comprising a plurality of third party resource usage records by a group-based communication server.

As used herein, the term “third party user account” refers to information associated with a user and a third party resource provider for authenticating a client device associated with the user to access a third party resource integrated in a group-based communication channel within a group-based communication system, including an email address, a username, a password, and the like.

As used herein, the term “third party resource integration user confirmation” refers to an electronically generated confirmation from a client device to confirm a third party resource integration. The group-based communication system may generate third party user account integration request in response to receiving a third party resource integration user confirmation.

As used herein, the term “third party resource integration user dismissal” refers to an electronically generated from a client device to dismiss a third party resource integration. Once the third party resource integration is dismissed, the client device may stop rendering the third party resource integration interface.

As used herein, the term “third party user account integration request” refers to an electronically generated request from the group-based communication system for integrating to a third party resource to be integrated in a workspace within a group-based communication system. In some embodiments, the third party resource may be already integrated within the group-based communication system even though it is not integrated with the specific workspace yet. A third party user account integration request may include a user identifier and a third party resource provider identifier to identify the user associated with the client device and the third party resource the client device would like to access.

As used herein, the term “third party resource integration provider confirmation” refers to an electronically generated confirmation from the third party resource provider to confirm integration of the third party resource for a workspace.

As used herein, the term “third party resource access token” refers to a set of security credentials associated with one or more third party resource providers for authenticating a user's identity in a group-based communication system. The third party resource access token may be used for granting a client device access to the one or more third party resources served by the third party resource providers. In one example, a third party resource access token may be a cryptic string that is issued to a group-based communication server by an authentication server with an approval of a third party resource provider. The group-based communication server may send a third party user account creation request along with a third party resource access token to a third party resource provider for creating a third party user account on behalf of a client device. In such an example, the third party resource provider may grant a third party user account creation approval after the authentication server verified the third party resource access token.

As used herein, the term “third party resource usage record” refers to set of data associated with a user identifier indicating whether a client device associated with the user identifier has accessed a third party user account associated with a third party resource provider. A third party resource usage record may include a user identifier, a third party resource provider identifier, and a third party resource access token indicating a third party user account associated with the third party resource provider has been accessed. In one example, a third party resource usage record may include a user identifier, a first third party resource provider identifier, and a first third party resource access token indicating a user associated with the user identifier has created a first third party user account served by a first third party resource provider. In some embodiments, the third party resource usage record may be associated with a group-based communication channel identifier, a group-identifier, or an organization identifier associated with the user identifier.

As used herein, the term “third party resource usage indicators” refers to a set of data associated with a user profile indicating how often a client device associated with the user profile requests access or logs-in to one or more third party resources. In one example, a first third party resource usage indicator may be a value representative of how many times the client device has requested access or logged-in to a first third party resource. In such an example, a large value of a third party resource usage indicator represents a high frequency of the third party resource usage.

As used herein, the term “third party resource usage map” refers to set of data comprising a plurality of third party resource usage records.

As used herein, the term “third party resource integration interface” refers to an interface that, when rendered for display on a client device, provides an indication to a user of a client device that a third party resource is available for access by the client device in a group-based communication channel within a group-based communication system. In one example, a third party resource integration interface may provide an indication to a user of the client device that a third party resource is available for access within a group with which the user of the client device is associated in a group-based communication system. In another example, a third party resource integration interface may provide an indication to a user of the client device that a third party resource is available for access within a group-based communication channel with which the user of the client device is associated in a group-based communication system. In another example, a third party resource integration interface may provide an indication to a user of the client device that a third party resource is available for access within an organization with which the user of the client device is associated in a group-based communication system. A third party resource integration interface may include any text, image, video, audio, or combination thereof associated with a third party resource. In some examples, a third party resource integration interface may include text (e.g., product name of a third party resource) as well as image data (e.g., an icon representing a third party resource or trademark of a third party resource provider). In some examples, a third party resource integration interface is configured to render for display on a client device as a suggestion to a user of the client device to request access to a third party resource.

A user to user link score is a numerical value representing a user's association with other users. In some embodiments, a user to user link score is derived using a user work graph. A user work graph is a graph-based knowledge representation data structure applied to the group-based communication system data corpus that represents a user's associations to other users. Such other users may be drawn from group-based communication messaging data, external communication objects, or the like. In one implementation, user to user data include how many messages from another user the user read, how many messages of another user the user reacted to, how many direct messages the user sent to another user, how many channels the user and another user joined in common, how many emails are transmitted from an email address and/or the like. Additionally or alternatively, user to user data include such as how may emails are transmitted between email addresses associated with the user and another user, recency of the emails transmitted between the email addresses associated with the user and another user, and/or the like. A weighted average of user to user data may be calculated for each of the other users from the perspective of the selected user, and the resulting scores normalized so that each of the other users is assigned a user to user link score (e.g., in the 0 to 1 range) from the perspective of the user.

A user to content affinity score is a numerical value representing a user's associations to topics. In some embodiments, a user to user link score is derived using a topic work graph. A topic work graph is a graph-based knowledge representation data structure applied to the group-based communication system data corpus that represents a user's associations to topics. Such topics may be drawn from group-based communication messaging data, group-based communication channel data, and group-based communication work object data and external communication object. In some embodiments, topics may be identified from a group-based communication message or an external communication object. The message contents or the content in the external communication may be parsed (e.g., using PHP commands) to determine topics discussed in the message/email. For example, hashtags in the message/email may indicate topics associated with the message/email. In another example, the message/email may be analyzed (e.g., by itself, with other messages/emails in a conversation primitive or parsed using a machine learning technique, such as topic modeling, to determine topics associated with the message. The topic work graph may indicate, for example, how many messages/emails a user sent regarding a topic, how many messages the user read regarding the topic, how many reactions to the user's messages/emails regarding the topic have been received, how many times files regarding the topic that were attached to the user's messages/emails have been downloaded by other users, how many times files regarding the topic have been downloaded by the user, and relative strengths of the user's associations with such topics. This data structure may be used to calculate a prioritization weight estimate of the topic to the user. For example, a weighted average of user to topic data may be calculated for each topic (e.g., each topic discussed by the team, each topic discussed at the company), and the resulting scores normalized so that each of the topics is assigned a prioritization weight estimate (e.g., in the 0 to 1 range) from the perspective of the user.

A “channel work graph” is a graph-based knowledge representation data structure applied to the group-based communication system data corpus that represents a user's associations to group-based communication channels. In another embodiment, such channel work graph may represent associations between channels without respect to a selected user. Returning to user-channel associations, in one example, the channel work graph may include associations developed based on whether the user joined a channel, how many messages the user sent in the channel, how many messages the user read in the channel, how often the user checks the channel, whether the user starred the channel, how similar the channel is to other channels the user participates in, and/or the like may be used to calculate a channel priority (e.g., a channel priority score) of the channel to the user. For example, a weighted average of user to channel data may be calculated for each channel (e.g., each channel accessible to the team, each channel accessible to the company), and the resulting scores normalized so that each of the channels is assigned a channel priority score (e.g., in the 0 to 1 range) from the perspective of the user.

A “third party application work graph” is a graph-based knowledge representation data structure applied to the group-based communication system data corpus that represents one or more users' or one or more organizations' associations to a third party resource provider. In some embodiments, the third party application work graph may represent associations with a group identifier or an organization to third party resource providers. The third party application work graph may be generated based on third party resource usage records which are sets of data associated with user identifiers indicating whether client devices associated with the user identifiers have accessed a third party user account associated with a third party resource provider. In addition, the third party application work graph may be generated based on third party resource usage indicators which are sets of data associated with user profiles indicating how often client device(s) associated with the user profile(s) requests access or logs-in to one or more third party resources.

A “third party application content work graph” is a graph-based knowledge representation data structure applied to the group-based communication system data corpus that represents a topic's associations to a third party resource provider. The topic may be a topic associated with a user to content score.

As used herein, the term “organization similarity score” refers to a numerical value representing similarity between one organization and another organization. In some embodiments, organization similarity score may be derived based on various information regarding the organization, including but not limited to one or more of: size of organization, one or more user identifiers associated with the organization(s), one or more group-based communication messages associated with the organization(s), one or more group-based communication channel identifiers associated with the organization(s), one or more third party resource provider identifiers associated with the organization(s), or one or more pre-defined categories associated with the organization(s).

### Example System Architecture

Methods, apparatuses, and computer program products of the present invention may be embodied by any of a variety of devices. For example, the method, apparatus, and computer program product of an example embodiment may be embodied by a networked device (e.g., an enterprise platform), such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

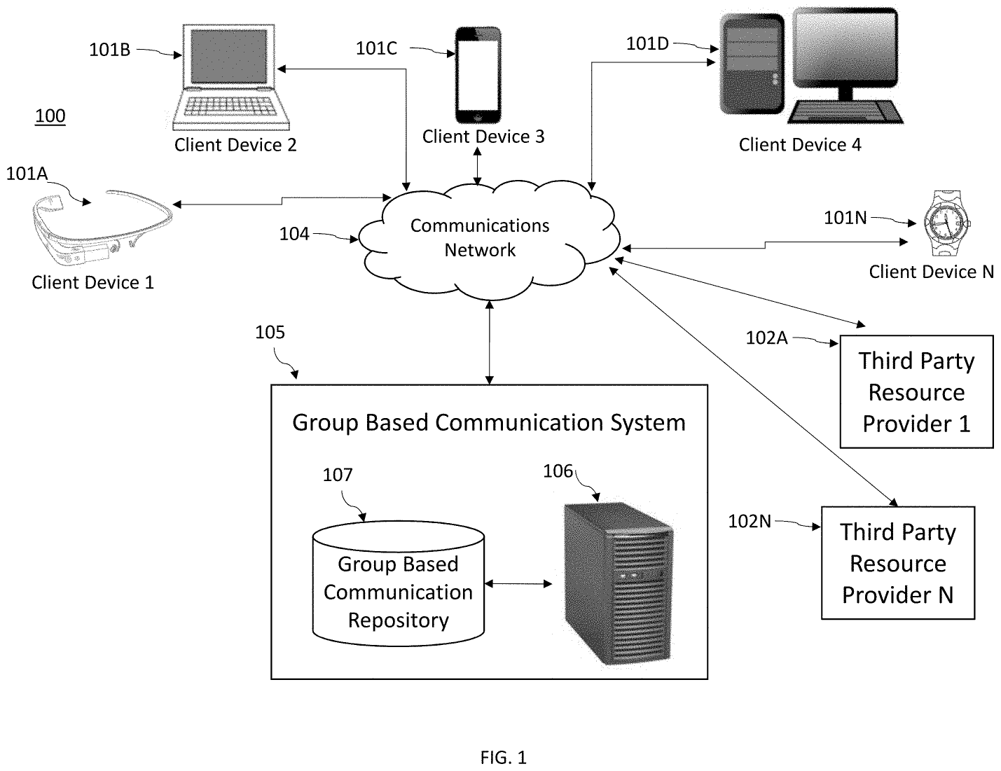

FIG. 1 illustrates an example computing system 100 within which embodiments of the present disclosure may operate. Users may access a group-based communication system 105 via a communications network 104 using client devices 101A-101N. Third party resource providers 102A-102N may interact with a group-based communication system 105 via a communications network 104. The group-based communication system 105 may comprise a group-based communication server 106 in communication with at least one group-based communication repository 107.

Communications network 104 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communications network 104 may include a cellular telephone, an 802.11, 802.16, 802.20, and/or WiMax network. Further, the communications network 104 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON objects sent via a Websocket channel. In some embodiments, the protocol is JSON over RPC, JSON over REST/HTTP, and the like.

The group-based communication server 106 may be embodied as a computer or computers as known in the art. The group-based communication server 106 may provide for receiving of electronic data from various sources, including but not necessarily limited to the client devices 101A-101N. For example, the group-based communication server 106 may be operable to receive and post or transmit group-based messaging communications provided by the client devices 101A-101N.

The group-based communication repository 107 may be embodied as a data storage device such as a Network Attached Storage (NAS) device or devices, or as a separate database server or servers. The group-based communication repository 107 includes information accessed and stored by the group-based communication server 106 to facilitate the operations of the group-based communication system 105. For example, the group-based communication repository 107 may include, without limitation, a plurality of messaging communications organized among a plurality of group-based communication channels, and/or the like.

The client devices 101A-101N may be any computing device as defined above. Electronic data received by the group-based communication server 106 from the client devices 101A-101N may be provided in various forms and via various methods. For example, the client devices 101A-101N may include desktop computers, laptop computers, smartphones, netbooks, tablet computers, wearables, and the like.

The third party resource providers 102A-102N may be remote networked devices, such as a server or processing device, maintained by a third party, and configured to provide third party resources integrated in the group-based communication system 105 for access by the client devices 101A-101N. The client devices 101A-101N can communicate with the third party resource providers 102A-102A via the communication network 104.

In embodiments where a client device 101A-101N is a mobile device, such as a smart phone or tablet, the client device 101A-101N may execute an “app” to interact with the group-based communication system 105. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

Additionally or alternatively, the client device 101A-101N may interact with the group-based communication system 105 via a web browser. As yet another example, the client device 101A-101N may include various hardware or firmware designed to interface with the group-based communication system 105.

In some embodiments of an exemplary group-based communication system 105, a message or messaging communication may be sent from a client device 101A-101N to a group-based communication system 105. In various implementations, the message may be sent to the group-based communication system 105 over communications network 104 directly by a client device 101A-101N, the message may be sent to the group-based communication system 105 via an intermediary such as a message server, and/or the like. For example, the client device 101A-101N may be a desktop, a laptop, a tablet, a smartphone, and/or the like that is executing a client application (e.g., a group-based communication app). In one implementation, the message may include data such as a message identifier, sending user identifier, a group identifier, a group-based communication channel identifier, message contents (e.g., text, emojis, images, links), attachments (e.g., files), message hierarchy data (e.g., the message may be a reply to another message), third party metadata, and/or the like. In one embodiment, the client device 101A-101N may provide the following example message, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>ID_user_1</user_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <client_details> //iOS Client with App and Webkit
      //it should be noted that although several client details
      //sections are provided to show example variants of client
      //sources, further messages will include only one to save
      //space
    <client_IP>10.0.0.123</client_IP>
    <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
    <client_product type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>app with webkit</client_app_type>
    <app_installed_flag>true</app_installed_flag>
    <app_name>application•.app</app_name>
    <app_version>1.0 </app_version>
    <app_webkit_name>Mobile Safari</client_webkit_name>
    <client_version>537.51.2</client_version>
  </client_details>
  <client_details> //iOS Client with Webbrowser
    <client_IP>10.0.0.123</client_IP>
    <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>web browser</client_app_type>
    <client_name>Mobile Safari</client_name>
    <client_version>9537.53</client_version>
  </client_details>
  <client_details>// Android Client with Webbrowser
    <client_IP>10.0.0.123</client_IP>
    <user_agent_string>Mozilla/5.0 (Linux; U; Android 4.0.4; en-us; Nexus S
Build/IMM76D) AppleWebKit/534.30 (KHTML, like Gecko) Version/4.0 Mobile
Safari/534.30</user_agent_string>
    <client_product_type>Nexus S</client_product_type>
    <client_serial_number>YXXXXXXXXZ</client_serial_number>
    <client_UDID>FXXXXXXXXX-XXXX-XXXX-XXXX-
XXXXXXXXXXXXX</client_UDID>
    <client_OS>Android</client_OS>
    <client_OS_version>4.0.4</client_OS_version>
    <client_app_type>web browser</client_app_type>
    <client_name>Mobile Safari</client_name>
    <client_version>534.30</client_version>
  </client_details>
  <client_details> //Mac Desktop with Webbrowser
    <client_IP>10.0.0.123</client_IP>
    <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
    <client_product_type>MacPro5,1</client_product_type>
    <client_serial_number>YXXXXXXXXZ</client_serial_number>
    <client_UDID>FXXXXXXXXX-XXXX-XXXX-XXXX-
XXXXXXXXXXXXX</client_UDID>
    <client_OS>Mac OS X</client_OS>
    <client_OS_version>10.9.3</client_OS_version>
    <client_app_type>web browser</client_app_type>
    <client_name>Mobile Safari</client_name>
    <client_version>537.75.14</client_version>
  </client_details>
  <message>
    <message_identifier>ID_message_10</message_identifier>
    <team_identifier>ID_team_1</team_identifier>
    <channel_identifier>ID_channel_1</channel_identifier>
    <contents>That is an interesting invention. I have attached a copy our patent
policy.</contents>
    <attachments>patent_policy.pdf</attachments>
  </message>
</auth_request>
```

The group-based communication system 105 comprises at least one group-based communication server 106 that may create a storage message based upon the received message to facilitate message indexing and storage in a group-based communication repository 107. In one implementation, the storage message may include data such as a message identifier, a group identifier, a group-based communication channel identifier, a sending user identifier, topics, responses, message contents, attachments, message hierarchy data, third party metadata, conversation primitive data, and/or the like. For example, the group based communication server 106 may provide the following example storage message, substantially in the form of a HTTP(S) POST message including XML-formatted data, as provided below:

```
POST /storage_message.php HTTP/1.1
Host: www.server.com
Content-Type: Application/XML
Content-Length: 667
<?XML version = “1.0” encoding = “UTF-8”?>
<storage_message>
  <message_identifier>ID_message_10</message_identifier>
  <team_identifier>ID_team_1</team_identifier>
  <channel_identifier>ID_channel_1</channel_identifier>
  <sending_user_identifier>ID_user_1</sending_user_identifier>
  <topics>
    <topic>inventions</topic>
    <topic>patents</topic>
    <topic>policies</topic>
  </topics>
  <responses>
    <response>liked by ID_user_2</response>
    <response>starred by ID_user_3</response>
  </responses>
  <contents>That is an interesting invention. I have attached a copy our patent
policy.</contents>
  <attachments>patent_policy.pdf</attachments>
  <conversation_primitive>
    conversation includes messages: ID_message_8, ID_message_9, ID_message_10,
    ID_message_11, ID_message_12
  </conversation_primitive>
</storage_message>
```

In embodiments, a group identifier as defined above may be associated with the message.

In embodiments, a group-based communication channel identifier as defined above may be associated with the message.

In embodiments, a sending user identifier as defined above may be associated with the message. In one implementation, the message may be parsed (e.g., using PHP commands) to determine a sending user identifier of the user who sent the message.

In embodiments, topics may be associated with the message. In one implementation, the message contents may be parsed (e.g., using PHP commands) to determine topics discussed in the message. For example, hashtags in the message may channels associated with the message. In another example, the message may be analyzed (e.g., by itself, with other messages in a conversation primitive) or parsed using a machine learning technique, such as topic modeling, to determine topics associated with the message.

In embodiments, data indicating responses may be associated with the message. For example, responses to the message by other users may include reactions (e.g., selection of an emoji associated with the message, selection of a “like” button associated with the message), clicking on a hyperlink embedded in the message, replying to the message (e.g., posting a message to the group-based communication channel in response to the message), downloading a file associated with the message, sharing the message from one group-based communication channel to another group-based communication channel, pinning the message, starring the message, and/or the like. In one implementation, data regarding responses to the message by other users may be included with the message, and the message may be parsed (e.g., using PHP commands) to determine the responses. In another implementation, data regarding responses to the message may be retrieved from a database. For example, data regarding responses to the message may be retrieved via a MySQL database command similar to the following:

SELECT messageResponses
FROM MSM_Message
WHERE messageID = ID_message_10.

For example, data regarding responses to the message may be used to determine context for the message (e.g., a social score for the message from the perspective of some user). In another example, data regarding responses to the message may be analyzed to determine context regarding the user (e.g., the user's expertise in a topic may be determined based on the responses to the user's message regarding the topic).

In embodiments, attachments may be included with the message. If there are attachments, files may be associated with the message. In one implementation, the message may be parsed (e.g., using PHP commands) to determine file names of the attachments. For example, file contents may be analyzed to determine context for the message (e.g., a patent policy document may indicate that the message is associated with the topic “patents”).

In embodiments, third party metadata may be associated with the message. For example, third party metadata may provide additional context regarding the message or the user that is specific to a company, group, group-based communication channel, and/or the like. In one implementation, the message may be parsed (e.g., using PHP commands) to determine third party metadata. For example, third party metadata may indicate whether the user who sent the message is an authorized representative of the group-based communication channel (e.g., an authorized representative may be authorized by the company to respond to questions in the group-based communication channel).

In embodiments, a conversation primitive may be associated with the message. In one implementation, a conversation primitive is an element used to analyze, index, store, and/or the like messages. For example, the message may be analyzed by itself, and may form its own conversation primitive. In another example, the message may be analyzed along with other messages that make up a conversation, and the messages that make up the conversation may form a conversation primitive. In one implementation, the conversation primitive may be determined as the message, a specified number (e.g., two) of preceding messages and a specified number (e.g., two) of following messages. In another implementation, the conversation primitive may be determined based on analysis of topics discussed in the message and other messages (e.g., in the channel) and/or proximity (e.g., message send order proximity, message send time proximity) of these messages.

In embodiments, various metadata, determined as described above, and/or the contents of the message may be used to index the message (e.g., using the conversation primitive) to facilitate various facets of searching (i.e., search queries that return results from group-based communication repository 107). In one implementation, a storage message may be sent from group-based communication server 106 to facilitate indexing in group-based communication repository 107. In another implementation, metadata associated with the message may be determined and the message may be indexed in group-based communication repository 107. In one embodiment, the message may be indexed such that a company's or a group's messages are indexed separately (e.g., in a separate index associated with the group and/or company that is not shared with other groups and/or companies). In one implementation, messages may be indexed at a separate distributed repository (e.g., to facilitate data isolation for security purposes).

If there are attachments associated with the message, file contents of the associated files may be used to index such files in group-based communication repository 107 to facilitate searching. In one embodiment, the files may be indexed such that a company's or a group's files are indexed at a separate distributed repository.

### Example Apparatus for Implementing Embodiments of the Present Disclosure

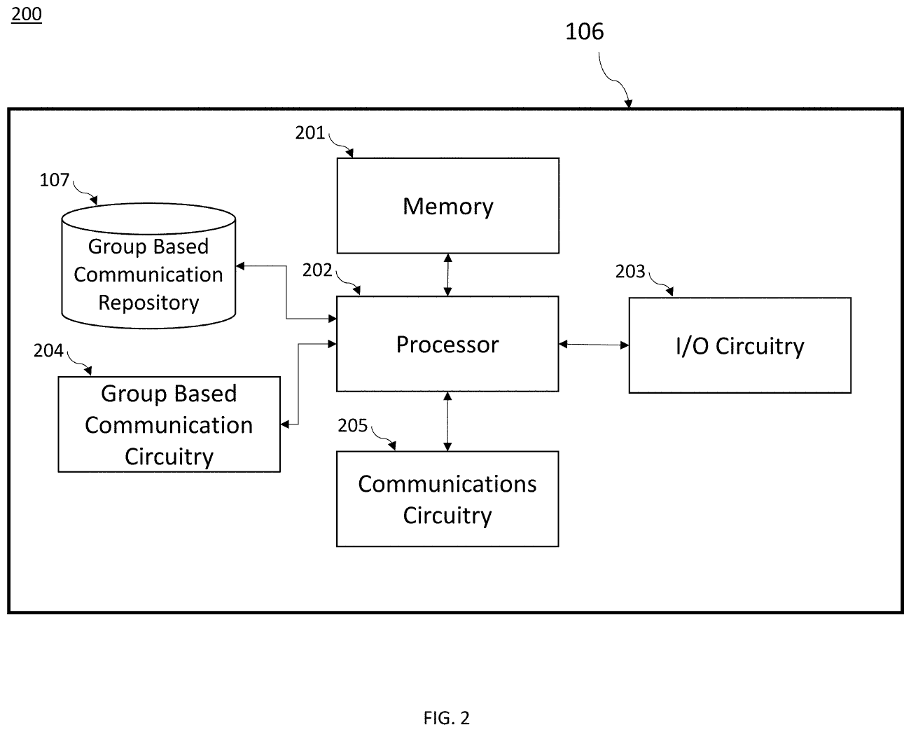

The server 106 may be embodied by one or more computing systems, such as apparatus 200 shown in FIG. 2. The apparatus 200 may include a processor 202, a memory 201, input/output circuitry 203, communications circuitry 205, group-based communication repository 107 and group-based communication circuitry 204. The apparatus 200 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 200 may provide or supplement the functionality of particular circuitry. For example, the processor 202 may provide processing functionality, the memory 201 may provide storage functionality, the communications circuitry 205 may provide network interface functionality, and the like.

In some embodiments, the processor 202 (and/or co-processor or any other processing circuitry assisting or otherwise associated with the processor) may be in communication with the memory 201 via a bus for passing information among components of the apparatus. The memory 201 may be non-transitory and may include, for example, one or more volatile and/or non-volatile memories. In other words, for example, the memory may be an electronic storage device (e.g., a computer readable storage medium). The memory 201 may be configured to store information, data, content, applications, instructions, or the like, for enabling the apparatus to carry out various functions in accordance with example embodiments of the present disclosure.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 201 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 203 that may, in turn, be in communication with processor 202 to provide output to the user and, in some embodiments, to receive an indication of a user input. The input/output circuitry 203 may comprise a user interface and may include a display and may comprise a web user interface, a mobile application, a client device, a kiosk, or the like. In some embodiments, the input/output circuitry 203 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 201, and/or the like).

The communications circuitry 205 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 205 may include, for example, a network interface for enabling communications with a wired or wireless communication network. For example, the communications circuitry 205 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The group-based communication circuitry 204 includes hardware configured to support a group-based communication system. The group-based communication circuitry 204 may utilize processing circuitry, such as the processor 202, to perform these actions. The group-based communication circuitry 204 may send and/or receive data from group-based communication repository 107. In some implementations, the sent and/or received data may be of enterprise-based digital content objects organized among a plurality of group-based communication channels. It should also be appreciated that, in some embodiments, the group-based communication circuitry 204 may include a separate processor, specially configured field programmable gate array (FPGA), or application specific interface circuit (ASIC).

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein.

### Example Third Party Resource Usage Map

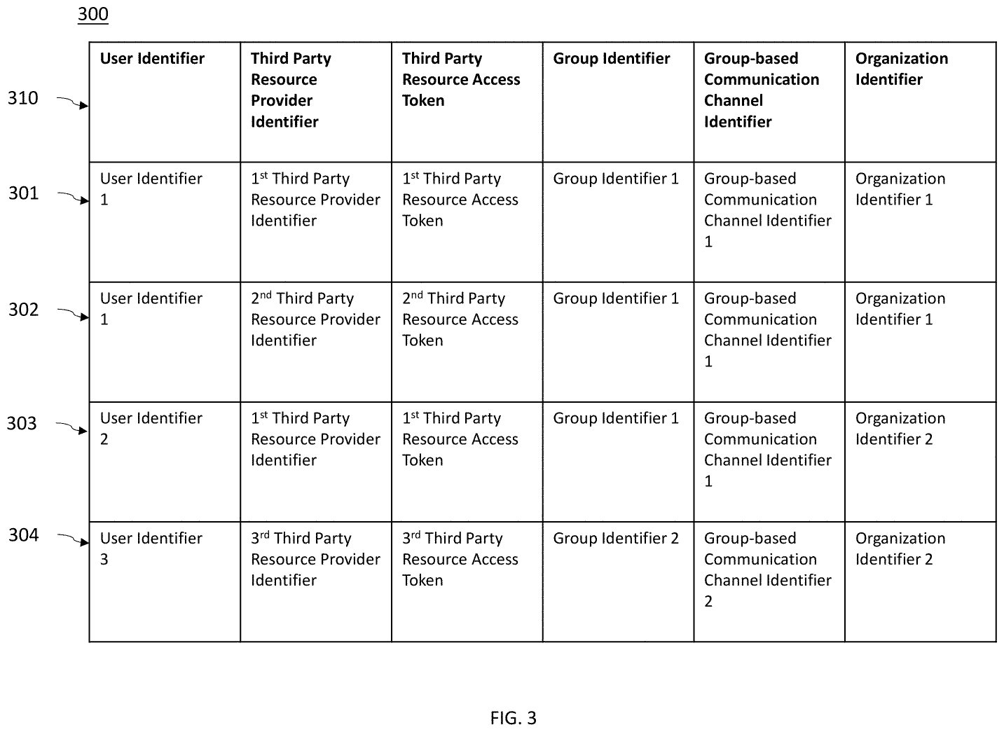

FIG. 3 is an exemplary third party resource usage map for use with embodiments of the present disclosure. The exemplary third party resource usage map 300 comprises a plurality of information types 310 associated with third party resource usage records 301-304. The information types 310 associated with the third party resource usage records 301-304 may include a user identifier, a third party resource provider identifier, and a third party resource access token associated with a third party resource provider. In one example, the third party resource usage records 301-304 may further comprise a group identifier, a group-based communication channel identifier, or an organization identifier.

### Example Group-Based Communication System Operations

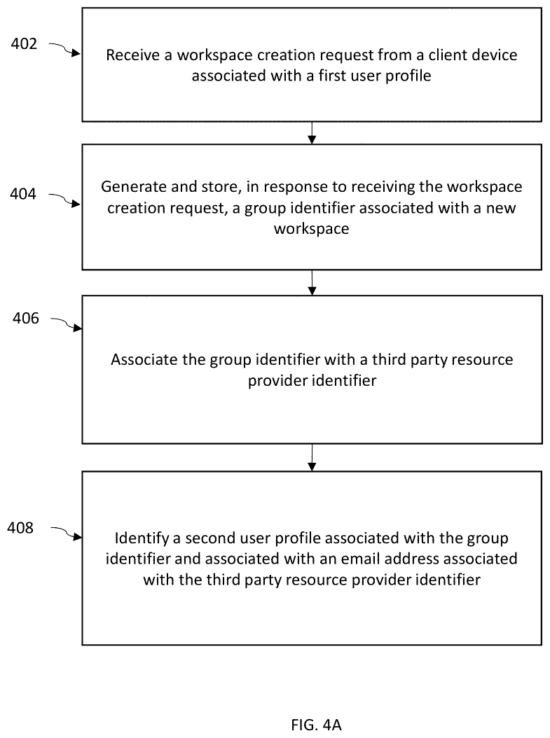

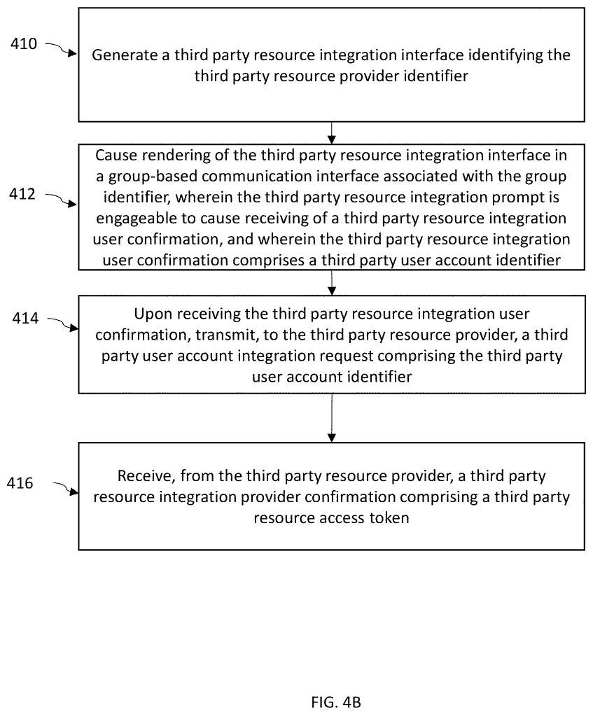

Referring now to FIGS. 4A and 4B, combined together, a flowchart is provided to illustrate operations that are executed by an example embodiment of an apparatus used to embody various components of the group-based communication system 110, such as the group-based communication server 106. FIGS. 4A and 4B and other flowcharts herein are for illustrative purposes and are not to be limiting unless otherwise stated herein. Unless otherwise noted, various operations discussed in FIGS. 4A and 4B and other flowcharts may be used in the same or separate embodiments of the present disclosure.

As shown in Block 402 of FIG. 4A, the apparatus includes means, such as the communications circuitry 205, processor 202, or the like, for receiving a workspace creation request from a client device associated with a first user profile. The first user profile may be associated with a first user profile identifier associated with an organization identifier. For example, the apparatus may receive a workspace creation request from a client device associated with a user associated with ACME corporation. The user may want to create a workspace to enable group-based communication for a group of people within ACME corporation. For example, a project team leader of ACME corporation may want to create a workspace for the particular project team to enable group-based communication within the project team.

As shown in Block 404 of FIG. 4A, the apparatus includes means, such as the processor 202 or the like, for generating and storing, in response to receiving the workspace creation request, a group identifier associated with a new workspace. By generating and storing the group identifier associated with a new workspace, a new workspace is created. The workspace creation request may further include one or more user identifiers associated with one or more users to be invited to the new workspace as members. In some embodiments, one or more invitations are sent to one or more client devices associated with the one or more users upon creation of the new workspace. For example, the workspace creation request initiated by a user associated with ACME corporation may include user identifiers associated with one or more other users of the ACME corporation. The user identifiers associated with one or more other users of the ACME corporation may be pre-existing user identifiers or user identifiers generated based on other information, such as ACME e-mail addresses of the one or more other users. The user identifiers may be associated with one or more users that are invited by the user initiating the workspace creation request. Turning back to the project team leader example, when the project team leader initiates the workspace creation request via the client device, the project team leader may want to invite the project team members. Therefore, the workspace creation request may include one or more user identifiers associated with the project team members in various forms, such as in the form of ACME corporation e-mail addresses of the project team members. The ACME corporation e-mail addresses of the project team members may be provided by the project team leader. The workspace creation request may also include a user identifier, such as ACME corporation e-mail address, of the project team leader initiating the request.

As shown in Block 406 of FIG. 4A, the apparatus includes means, such as the processor 202 or the like, for associating the group identifier with a third party resource provider identifier. The third party resource provider identifier may be previously associated with another group identifier associated with the first user profile. In some embodiments, a third party resource identified by the third party resource provider identifier may already be integrated within the group-based communication system and may be utilized in one or more other workspaces associated with an organization identifier associated with the first user profile identifier. For example, the third party resource provider identifier may be associated with ABCD document management service providing document editing, storage, share, and other features. In some embodiments, the ABCD document management service may be previously utilized in one or more other workspaces associated with ACME corporation. Other example third party resource providers may provide different services such as a team planning service, a project tracking service, an image storage and sharing service, a calendar service, a social media or networking service, and the like.

In some embodiments, by way of example, the third party resource provider identifier is associated with the group-identifier for the purpose of recommending the third party resource for integration. In some embodiments, upon receiving workspace creation requests, the third party resource may be identified based on one or more pre-defined preferred third party resources associated with the organization identifier. For example, ACME corporation may be defined to prefer utilizing ABCD document management service. In some embodiments, the third party resource may be identified based on usage statistics associated with the third party resource. The usage statistics may be associated with the organization identifier, organizations identified to be similar to the organization identified in the organization identifier, or general usage statistics. For example, it may be determined that ABCD document management service is the most utilized third party resource for ACME corporation and ABCD document management service is recommended accordingly. In another example, it may be determined that ABCD document management service is the most utilized third party resource for AMCE corporation that is determined to be similar to ACME corporation; ABCD document management service is recommended accordingly. In another example, it may be determined that ABCD document management service is the most utilized third party resource among all organizations; ABCD document management service is recommended accordingly.

As shown in Block 408 of FIG. 4A, the apparatus includes means, such as the processor 202 or the like, for identifying a second user profile associated with the group identifier. In some embodiments, the second user profile is already associated with an email address associated with the third party resource provider identifier. Turning back to the project team leader example, the second user profile may be a user profile associated with any of the invited team members that registered with the ABCD document management service with their ACME corporation e-mail address. As such, while integrating ABCD document management service to the workspace, invited members of the newly created workspace that are existing users of ABCD document management service may be identified to facilitate integration of ABCD document management service to the workspace. For example, various files may be made available to enable the invited members of the newly created workspace that are existing users of ABCD document management service to quickly share their files stored on ABCD document management service within the workspace.

Continuing with FIG. 4B, as shown in Block 410 of FIG. 4B, the apparatus includes means, such as the processor 202 or the like, for generating a third party resource integration interface identifying the third party resource provider identifier. The third party resource integration interface may be generated to let a user confirm the third party resource provider integration.

As shown in Block 412 of FIG. 4B, the apparatus includes means, such as the communications circuitry 205, processor 202, or the like, for causing rendering of the third party resource integration interface in a group-based communication interface associated with the group identifier. In some embodiments, the third party resource integration prompt is engageable to cause receiving of a third party resource integration user confirmation. In some embodiments, the third party resource integration user confirmation comprises a third party user account identifier.

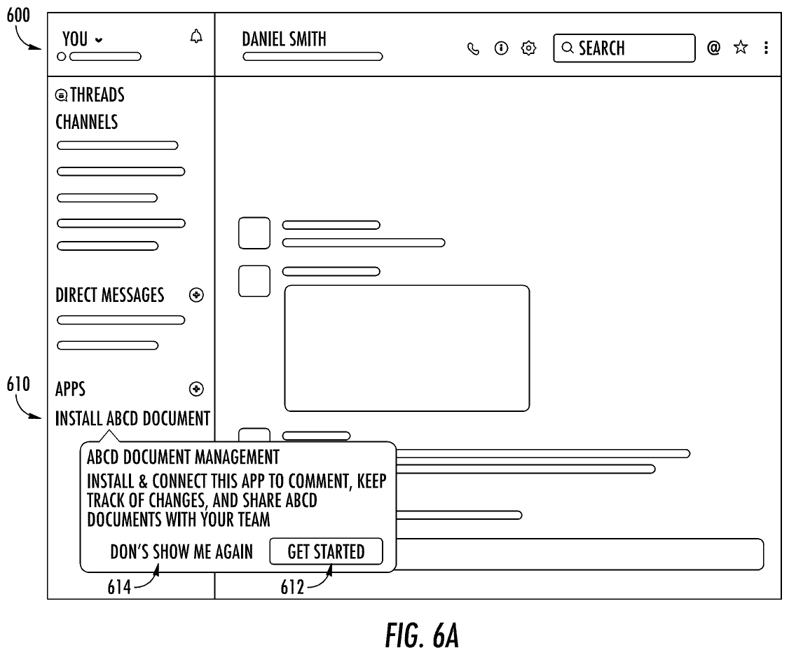

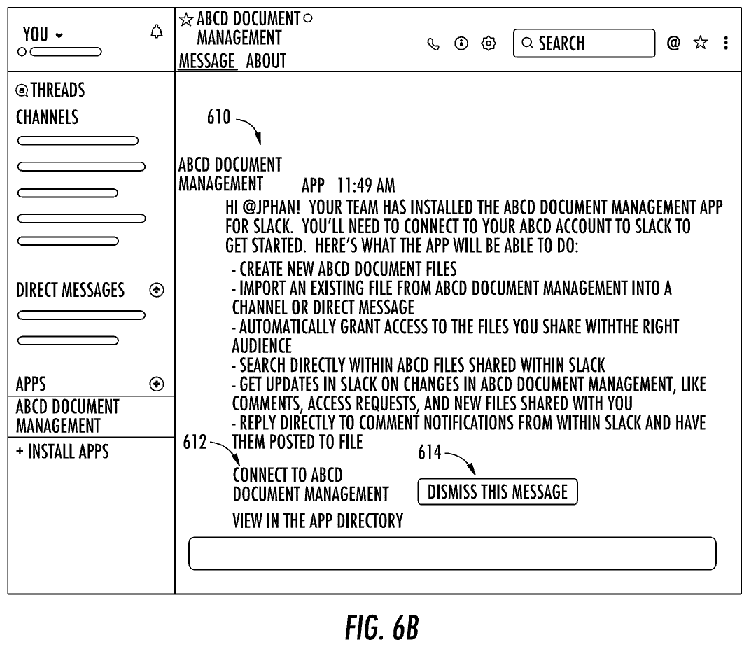

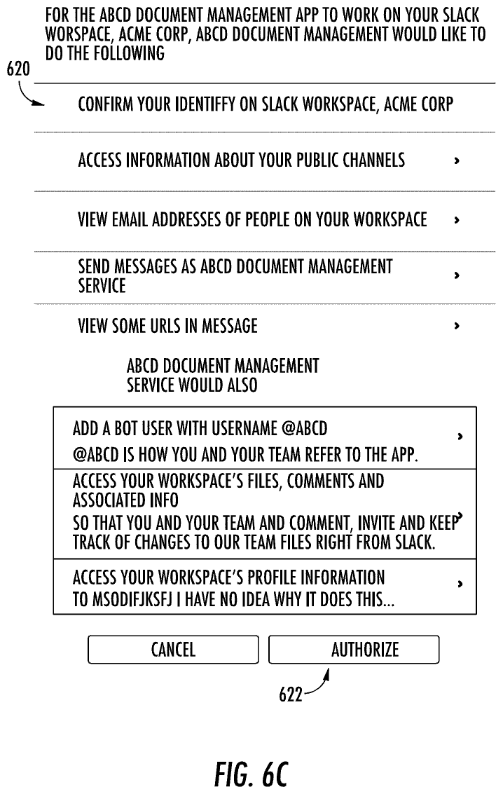

FIGS. 6A-6C illustrate example rendered third party resource integration interfaces according to embodiments of the present disclosure. As illustrated in FIG. 6A, a group-based communication interface 600 rendered includes a third party resource integration interface 610. The third party resource integration interface 610 identifies the third party resource provider ABCD document management service. The third party resource integration interface 610 includes two engageable input fields 612 and 614, which may be engageable by a user, such as the creator of the workspace, to provide third party resource integration user confirmation or third party resource integration user dismissal, respectively. In some embodiments, third party resource integration interface is configured to, when engaged, to render a description associated with the third party resource provider. For example, the description for ABCD document management service may provide a brief overview of ABCD document management service as illustrated in FIG. 6A: “Install & connect this app to comment, keep track of changes, and share ABCD documents with your team”. The description may be previously stored in the group-based communication system.

FIG. 6B illustrates an alternative third party resource integration interface 610. The third party resource integration interface 610 also includes two engageable input fields 612 and 614, which may be engageable by a user to provide third party resource integration user confirmation or third party resource integration user dismissal, respectively.

The third party resource integration user confirmation may include the ACME e-mail address associated with the user in order to confirm that the user has the right to confirm. For example, the user has the right to confirm third party resource integration of the user is the creator of the workspace or has been given right to confirm third party resource integration by the creator of the workspace, or the user has been given right to confirm third party resource integration in another way. For example, an information technology department user in ACME corporation may be given right to confirm third party resource integration by another policy governing third party resource integrations of ACME corporation workspaces.

FIG. 6C illustrates a description 620 associated with the third party resource rendered after third party resource integration interface is engaged. The description 620 may be previously stored in the group-based communication system. The description 620 may include description for one or more access rights that may be granted to the third party resource provider including one or more of: right to transmit third party resource access token, right to transmit group-based communication message, right to access one or more email addresses associated with one or more user identifiers associated with the workspace, or right to access information regarding one or more group-based communication channel associated with the second user profile. The access rights may further include the right to create a bot user profile in the group-based communication system. In some embodiments, engageable input field 622 may be engageable by a user to provide third party resource integration user confirmation. In some embodiments, the third party resource integration interface is further engageable to cause receiving of a third party resource integration user dismissal.

In some embodiments, the access rights may be access rights that the third party resource provider needs in order to facilitate the service provided and may change based upon the specific third party resource provider. For example, for third party resource providers, the right to transmit third party resource access token may be necessary to access files, such as documents for ABCD document management service, for sharing in group-based communication interface. The right to transmit group-based communication message, right to access information regarding one or more group-based communication channel, and right to create a bot user profile in the group-based communication system may be necessary for the third party resource provider to cause rendering of third party provided data of interest to users of the workspace, such as documents for ABCD document management service, within the group-based communication interface rendering the workspace.

As shown in Block 414 of FIG. 4B, the apparatus includes means, such as the communications circuitry 205, processor 202, or the like, for transmitting, to the third party resource provider, a third party user account integration request comprising the third party user account identifier upon receiving the third party resource integration user confirmation. A third party user account integration request is an electronically generated request from the group-based communication system for integrating to a third party resource to be integrated in a workspace within a group-based communication system. In some embodiments, the third party resource may be already integrated within the group-based communication system even though it is not integrated with the specific workspace yet. For example, as previously discussed, ABCD document management service may be previously integrated with other workspaces associated with ACME corporation even though ABCD document management service is not integrated with the specific newly created workspace yet. A third party user account integration request may include a user identifier and a third party resource provider identifier to identify the user associated with the client device and the third party resource the user would like to access. For example, the group-based communication system may transmit an ACME e-mail address serving as a user identifier, along with identifier associated with ABCD document management service, within the third party user account integration request.

As shown in Block 416 of FIG. 4B, the apparatus includes means such as the communications circuitry 205, processor 202, or the like, for receiving, from the third party resource provider, a third party resource integration provider confirmation comprising a third party resource access token. For example, the apparatus may receive an ABCD document management service access token from an ABCD document management service server. The access token may be necessary for accessing documents stored on ABCD document management service server for rendering within a group-based communication interface.

The operations illustrated in FIGS. 4A and 4B may be repeated for more than 1 users. In some embodiments, the apparatus includes means such as the communications circuitry 205, processor 202, or the like, for recording a number of interactions with the third party resource integration interface, recording a number of interactions with the third party resource integration interface that indicates a third party resource integration user dismissal, or recording a number of interactions with the third party resource integration interface that indicates a third party resource integration user confirmation. In some embodiments, number of interactions may be recorded by one or more client devices associated with one or more users and the apparatus may record the collective number of interactions recorded by all the client devices.

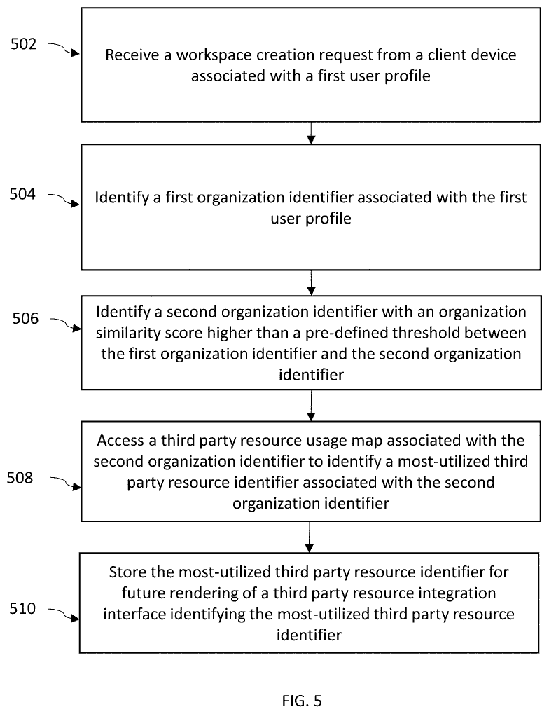

Referring now to FIG. 5, a flowchart is provided to illustrate operations that are executed by an example embodiment of an apparatus used to embody various components of the group-based communication system 110, such as the group-based communication server 106.

As shown in Block 502 of FIG. 5, the apparatus includes means, such as the communications circuitry 205, processor 202, or the like, for receiving a workspace creation request from a client device associated with a first user profile. The first user profile may be associated with a first user profile identifier associated with an organization identifier. For example, the apparatus may receive a workspace creation request from a user associated with ACME corporation as previously described with reference to FIGS. 4A and 4B.

As shown in Block 504 of FIG. 5, the apparatus includes means, such as the processor 202 or the like, for identifying a first organization identifier associated with the first user profile. For example, an identifier associated with ACME corporation may be identified in the first user profile.

As shown in Block 506 of FIG. 5, the apparatus includes means, such as the processor 202 or the like, for identifying a second organization identifier with an organization similarity score higher than a pre-defined threshold between the first organization identifier and the second organization identifier. Organization similarity score is a numerical value representing similarity between one organization and another organization. In some embodiments, organization similarity score may be derived based on various information regarding the organization, including but not limited to one or more of: size of organization, one or more user identifiers associated with the organization(s), one or more third party resource provider identifiers associated with the organization(s), or one or more pre-defined categories associated with the organization(s). For example, the apparatus may identify that AMCE corporation, a separate organization from ACME corporation, is similar to ACME corporation based on the organization similarity score. ACME corporation may be similar to AMCE corporation in size, other third party resources utilized for ACME users and AMCE users, and ACME corporation and AMCE corporation may be both in the category of providing consulting service.

As shown in Block 508 of FIG. 5, the apparatus includes means, such as the processor 202 or the like, for accessing a third party resource usage map associated with the second organization identifier to identify a most-utilized third party resource identifier associated with the second organization identifier. The most-utilized third party resource identifier may be determined using various metrics, including but not limited to one or more third party resource usage indicators associated with one or more user profiled associated with the second organization identifier. In some embodiments, the apparatus may further access a third party application work graph to identify the most-utilized third party resource identifier. For example, the apparatus may access a third party resource usage map representing third party resource usage information associated with AMCE corporation to identify that ABCD document management service is the most or one of the most-utilized third party resources for AMCE corporation, which is determined to be similar to ACME corporation.

As shown in Block 510 of FIG. 5, the apparatus includes means, such as the processor 202 or the like, for storing the most-utilized third party resource identifier for future rendering of a third party resource integration interface identifying the most-utilized third party resource identifier. The rendering of a third party resource integration interface may be triggered by the client device or the group-based communication system. Operations 412 to 416 illustrated in FIG. 4B may be performed by the group-based communication system after the rendering is triggered. For example, the apparatus may store information representing that ABCD document management service is the most-utilized third party resource for ACME corporation. Therefore, upon receiving workspace creation requests associated with an ACME corporation user or employee, the apparatus generates third party resource integration interface for ABCD document management service as described above with reference to FIGS. 4A and 4B. As such, when a new workspace is being created for ACME corporation, the ABCD document management service is recommended to be integrated based on the statistics collected described above with reference to FIG. 5.

Recommended third party resource may be identified in other ways as well. For example, ACME corporation may be defined to prefer utilizing ABCD document management service. In some embodiments, the third party resource may be identified based on usage statistics associated with the third party resource. The usage statistics may be associated with the organization identifier, organizations identified to be similar to the organization identified in the organization identifier, or general usage statistics. For example, it may be determined that ABCD document management service is the most utilized third party resource for ACME corporation and ABCD document management service is recommended accordingly. In another example, it may be determined that ABCD document management service is the most utilized third party resource among all organizations; ABCD document management service is recommended accordingly.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

As described above, FIGS. 4A, 4B, and 5 illustrate flowcharts of apparatuses and methods according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for managing integration of a third party resource in a group-based communication system, the apparatus comprising at least one processor and at least one memory including a computer program code, the at least one memory and the computer program code configured to, with the at least one processor, cause the apparatus to:
receive a workspace creation request from a client device associated with a first user profile identifier;
generate and store, in response to receiving the workspace creation request, a group identifier associated with a new workspace;
generate a third party resource integration interface comprising a third party resource provider identifier associated with the group identifier; and
cause rendering of the third party resource integration interface in a group-based communication interface associated with the group identifier, wherein the third party resource integration interface is engageable to cause receiving of a third party resource integration user confirmation, and wherein the third party resource integration user confirmation comprises a third party user account identifier.

2. The apparatus of claim 1, wherein the third party resource provider identifier is previously associated with another group identifier associated with the first user profile identifier.

3. The apparatus of claim 1, wherein a third party resource identified by the third party resource provider identifier is integrated within the group-based communication system and utilized in one or more other workspaces associated with an organization identifier associated with the first user profile identifier.

4. The apparatus of claim 1, wherein the third party resource integration interface is configured to, when engaged, to render a description associated with the third party resource provider identifier.

5. The apparatus of claim 4, wherein the description further comprises data representing one or more access rights comprising one or more of: right to transmit third party resource access token, right to transmit group-based communication message, right to access one or more email addresses associated with one or more user identifiers associated with the new workspace, or right to access information regarding one or more group-based communication channel associated with a second user profile.

6. The apparatus of claim 1, wherein the third party resource provider identifier is provided based on one or more of: a usage statistics of third party resources associated with the organization identifiers, a usage statistics of third party resources associated with one or more organizations similar to an organization identified by the organization identifier, or a general usage statistics.

7. The apparatus of claim 1, wherein the at least one memory and the computer program code further configured to, with the at least one processor, cause the apparatus to:
record a number of interactions with the third party resource integration interface that indicates a third party resource integration user dismissal.

8. The apparatus of claim 1, wherein the at least one memory and the computer program code further configured to, with the at least one processor, cause the apparatus to:
identify a second organization identifier with an organization similarity score higher than a pre-defined threshold between the organization identifier and the second organization identifier;
access a third party resource usage map associated with the second organization identifier to identify a most-utilized third party resource identifier associated with the second organization identifier;
store the most-utilized third party resource identifier as the third party resource provider identifier.

9. The apparatus of claim 1, wherein a second user profile is previously associated with an email address associated with the third party resource provider identifier.

10. The apparatus of claim 1, wherein the at least one memory and the computer program code further configured to, with the at least one processor, cause the apparatus to:
upon receiving the third party resource integration user confirmation, transmit, a third party resource provider associated with the third party resource provider identifier, a third party user account integration request comprising the third party user account identifier; and
receive, from the third party resource provider associated with the third party resource provider identifier, a third party resource integration provider confirmation comprising a third party resource access token.

11. A computer implemented method for managing integration of a third party resource in a group-based communication system, the method comprising:
receiving a workspace creation request from a client device associated with a first user profile identifier;
generating and storing, in response to receiving the workspace creation request, a group identifier associated with a new workspace;
generating a third party resource integration interface comprising a third party resource provider identifier associated with the group identifier; and
causing rendering of the third party resource integration interface in a group-based communication interface associated with the group identifier, wherein the third party resource integration interface is engageable to cause receiving of a third party resource integration user confirmation, and wherein the third party resource integration user confirmation comprises a third party user account identifier.

12. The method of claim 11, wherein the third party resource provider identifier is previously associated with another group identifier associated with the first user profile identifier.

13. The method of claim 11 wherein a third party resource identified by the third party resource provider identifier is integrated within the group-based communication system and utilized in one or more other workspaces associated with an organization identifier associated with the first user profile identifier.

14. The method of claim 11, wherein the third party resource integration interface is configured to, when engaged, to render a description associated with the third party resource provider identifier.

15. The method of claim 14, wherein the description further comprises data representing one or more access rights comprising one or more of: right to transmit third party resource access token, right to transmit group-based communication message, right to access one or more email addresses associated with one or more user identifiers associated with the new workspace, or right to access information regarding one or more group-based communication channel associated with a second user profile.

16. The method of claim 11, wherein the third party resource provider identifier is provided based on one or more of: a usage statistics of third party resources associated with the organization identifiers, a usage statistics of third party resources associated with one or more organizations similar to an organization identified by the organization identifier, or a general usage statistics.

17. The method of claim 11, further comprising:
recording a number of interactions with the third party resource integration interface that indicates a third party resource integration user dismissal.

18. The method of claim 16, further comprising:
identifying a second organization identifier with an organization similarity score higher than a pre-defined threshold between the organization identifier and the second organization identifier;
accessing a third party resource usage map associated with the second organization identifier to identify a most-utilized third party resource identifier associated with the second organization identifier;
storing the most-utilized third party resource identifier as the third party resource provider identifier.

19. The method of claim 11, wherein a second user profile is previously associated with an email address associated with the third party resource provider identifier.

20. The method of claim 11, further comprising:
upon receiving the third party resource integration user confirmation, transmitting, to a third party resource provider associated with the third party resource provider identifier, a third party user account integration request comprising the third party user account identifier; and
receiving, from the third party resource provider, a third party resource integration provider confirmation comprising a third party resource access token.
